(19) United States
(12) Patent Application Publication
(10) Pub. No.: US 2026/0025015 A1
(43) Pub. Date: Jan. 22, 2026

(54) PROTECTION CIRCUIT OF BATTERY AND OPERATING METHOD THEREOF

(71) Applicant: uPI semiconductor corp., Zhubei City, Hsinchu County (TW)

(72) Inventor: Chun-Kuei CHIU, Zhubei City, Hsinchu County (TW)

(21) Appl. No.: 18/661,786

(22) Filed: May 13, 2024

(30) Foreign Application Priority Data
May 16, 2023 (CN) 202310546822.9

(51) Int. Cl. H02J 7/00; H01M 10/44

(52) U.S. Cl. CPC H02J 7/62; H01M 10/448; H02J 7/685; H02J 7/855; H02J 7/94

(57) ABSTRACT

A protection circuit of battery and an operating method thereof are disclosed. The protection circuit of battery has a current sensing pin coupled to a path node. The path node, a battery cell and a protection switch are coupled in series. The protection circuit includes a disconnection detection circuit and a first over-current protection circuit. The disconnection detection circuit is coupled to the current sensing pin and provides a first detection signal. The first over-current protection circuit is coupled to the disconnection detection circuit and generates a first protection signal according to the first detection signal to turn off the protection switch. When the current sensing pin is disconnected from the path node, the first detection signal causes the first over-current protection circuit to generate the first protection signal.

### BACKGROUND OF THE INVENTION

### Field of the invention

The invention relates to battery; in particular, to a protection circuit of battery and an operating method thereof.

### Description of the prior art

Please refer to FIG. 1, which is a schematic diagram of a conventional battery primary protection integrated circuit (1PTIC) applied to a battery protection system. As shown in FIG. 1, the 1PTIC 10 applied to the battery protection system 1 has a plurality of pins P1 to P6. The pin P1 is the VDD pin, which is coupled to a positive electrode of a battery B through an RC filter composed of a resistor R2 and a capacitor C; the pin P2 is a VSS pin, which is coupled to a negative electrode of the battery B; the pin P3 is a CO pin, which is coupled to and controls a charging protection switch M2 to turn on or turn off a charging path; the pin P4 is a DO pin, which is coupled to and controls a discharge protection switch M1 to turn on or turn off a discharge path; the pin P5 is a negative voltage sensing (VM) pin, which is used to sense the voltage of the negative terminal P- and determine whether to connect an external device (such as a load or charger) according to the change of its voltage level; the pin P6 is a current sensing (CS) pin used to sense over-current on the charging path.

Since the pin P6 used to detect the battery current needs to sense the battery state at any time to provide over-current protection or short-circuit protection, the pin P6 needs to be configured with an open-wire protection (OWP) mechanism to avoid the pin P6 cannot sense the battery current due to disconnection. The conventional disconnection detection circuit is to set an additional current source in the pin P6, it not only makes increase the power consumption of the 1PTIC, but also makes prevent the size of the 1PTIC from being reduced. Therefore, the above-mentioned problems occurred in the prior arts still need to be solved.

### SUMMARY OF THE INVENTION

Therefore, the invention provides a protection circuit of battery and an operating method thereof to solve the above-mentioned problems of the prior arts.

A preferred embodiment of the invention is a protection circuit of battery. In this embodiment, the protection circuit of battery has a current sensing pin coupled to a path node. The path node, a battery cell and a protection switch are coupled in series. The protection circuit includes a disconnection detection circuit and a first over-current protection circuit. The disconnection detection circuit is coupled to the current sensing pin and provides a first detection signal. The first over-current protection circuit is coupled to the disconnection detection circuit and generates a first protection signal according to the first detection signal to turn off the protection switch. When the current sensing pin is disconnected from the path node, the first detection signal causes the first over-current protection circuit to generate the first protection signal.

In an embodiment, an operating current flows through the battery cell, when the current sensing pin is coupled to the path node, the first detection signal is related to the operating current.

In an embodiment, the disconnection detection circuit includes a current source and a first detection node, the first detection node is coupled to the current source, the current sensing pin and the first over-current protection circuit, when the current sensing pin is disconnected from the path node, the first detection node uses the current source to provide the first detection signal.

In an embodiment, the disconnection detection circuit further includes a resistor coupled between the first detection node and the current source, and the disconnection detection circuit generates a second detection signal at a second detection node between the resistor and the current source.

In an embodiment, the protection circuit further includes a second current protection circuit configured to detect a current flowing through the battery cell when the battery cell is in a charging state.

Another preferred embodiment of the invention is a method of operating a protection circuit of battery. In this embodiment, the protection circuit has a current sensing pin coupled to a path node. The path node, a battery cell and a protection switch are coupled in series. The protection circuit includes a disconnection detection circuit and a first over-current protection circuit. The disconnection detection circuit is coupled to the current sensing pin and the first over-current protection circuit is coupled to the disconnection detection circuit. The method includes steps of: (a) providing a first detection signal through the disconnection detection circuit; and (b) when the current sensing pin is disconnected from the path node, the first detection signal causing the first over-current protection circuit to generate a first protection signal to turn off the protection switch.

In an embodiment, the method further includes: when the current sensing pin is coupled to the path node, the first detection signal is related to an operating current flowing through the battery cell.

In an embodiment, the disconnection detection circuit includes a current source and a first detection node, the first detection node is coupled to the current source, the current sensing pin and the first over-current protection circuit, the method further includes: when the current sensing pin is disconnected from the path node, using the current source to provide the first detection signal through the first detection node.

In an embodiment, the disconnection detection circuit further includes a resistor coupled between the first detection node and the current source, the method further includes a step of: generating a second detection signal through a second detection node between the resistor and the current source.

In an embodiment, the protection circuit further includes a second current protection circuit, the method further includes a step of: detecting a current flowing through the battery cell when the battery cell is in a charging state through the second current protection circuit.

Compared to the prior art, the protection circuit of battery and its operating method of the invention can not only provide additional open-wire protection (OWP) function to the current sensing pin, but can also achieve the following effects at the same time:

(1) small increased power consumption: the power consumption of the disconnection detection circuit of the invention is about 50-100nA, which is only 1% of the power consumption (10-20uA) of the conventional disconnection detection circuit, so the increased power consumption is quite small; and

(2) small increased circuit area: the disconnection detection circuit of the invention is integrated with the over-current protection circuit, so the increased circuit area is quite small.

The advantage and spirit of the invention may be understood by the following detailed descriptions together with the appended drawings.

### BRIEF DESCRIPTION OF THE APPENDED DRAWINGS

FIG. 1 is a schematic diagram of a conventional battery primary protection integrated circuit (1PTIC) applied to a battery protection system.

FIG. 2 is a schematic diagram of a protection circuit of battery applied to a battery protection system in a specific embodiment of the invention.

FIG. 3 is a schematic diagram of an embodiment of the disconnection detection circuit in FIG. 2.

FIG. 4 is a schematic diagram of an embodiment of the first over-current protection circuit in FIG. 2.

FIG. 5 is a schematic diagram of an embodiment of the second over-current protection circuit in FIG. 2.

FIG. 6 is a waveform timing diagram of each signal when no disconnection occurs between the current sensing pin and the path node.

FIG. 7 is a waveform timing diagram of each signal when a disconnection occurs between the current sensing pin and the path node.

FIG. 8 is a flowchart of a method of operating a protection circuit of battery in another embodiment of the invention.

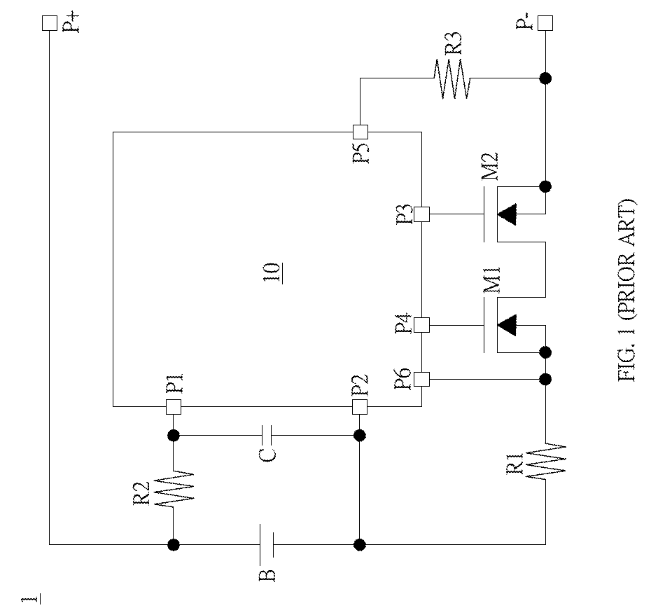

### DETAILED DESCRIPTION OF THE INVENTION

Reference will now be made in detail to the exemplary embodiments of the invention, examples of which are illustrated in the accompanying drawings. Elements/components with the same or similar numbers used in the drawings and embodiments are intended to represent the same or similar parts.

A specific embodiment of the invention is a protection circuit of battery. In this embodiment, the protection circuit of battery can be a battery primary protection integrated circuit (1PTIC), but not limited to this.

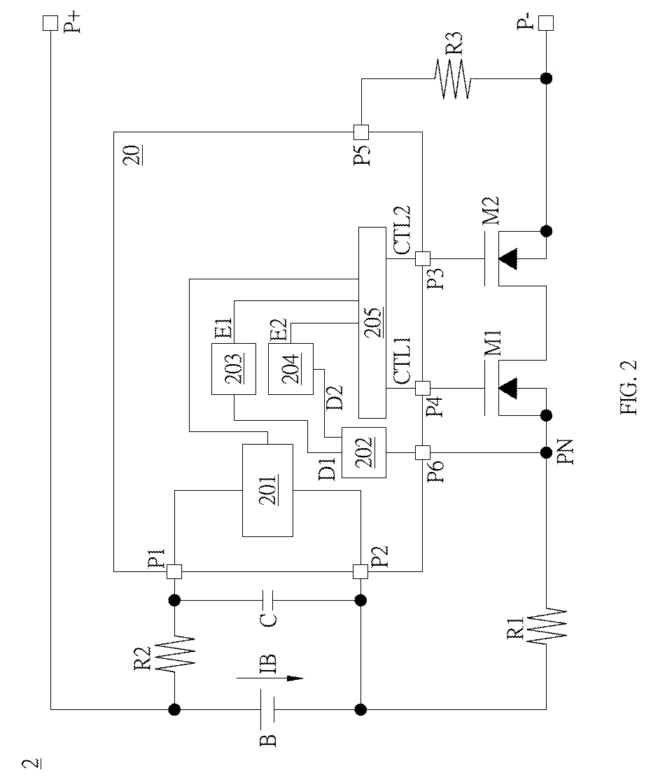

Please refer to FIG. 2. FIG. 2 is a schematic diagram of a protection circuit of battery applied to a battery protection system of a specific embodiment of the invention. As shown in FIG. 2, the protection circuit of battery 20 applied to the battery protection system 2 includes an over-voltage detection circuit 201, an open-wire detection circuit 202, a first over-current protection circuit 203, a second over-current protection circuit 204 and the control circuit 205 and the protection circuit of battery 20 also has pins P1 to P6.

In this embodiment, the first over-current protection circuit 203 is a discharge over-current detection circuit and the second over-current protection circuit 204 is a charge over-current detection circuit.

The pin P1 is coupled to one terminal of a resistor R2 and one terminal of a capacitor C. The resistor R2 is coupled to a positive electrode of a battery cell B and a positive terminal P+ of the battery protection system 2. The pin P2 is coupled to the other terminal of the capacitor C, a negative electrode of the battery cell B and one terminal of the resistor R1. The resistor R2 and the capacitor C form a filter circuit. The pin P3 is coupled to a control terminal of a charging protection switch M2 and controls the charging protection switch M2 to turn on or turn off a charging path. The pin P4 is coupled to a control terminal of a discharge protection switch M1 and controls the discharge protection switch M1 to turn on or turn off a discharge path. The pin P5 is coupled to one terminal of the resistor R3. The other terminal of the resistor R3 is coupled to a negative terminal P- of the battery protection system 2. The discharge protection switch M1 is coupled between the other terminal of the resistor R1 and the charging protection switch M2. The charging protection switch M2 is coupled between the discharge protection switch M1 and the negative terminal P- of the battery protection system 2. The pin P6 is a current sensing pin, which is coupled to a path node PN between the other terminal of the resistor R1 and the discharge protection switch M1. An operating current IB flows through the battery cell B. The battery cell B, the resistor R1, the path node PN, the discharge protection switch M1 and the charging protection switch M2 are coupled in series with each other to form a current path for the operating current IB. It should be noted that the battery can include one or more battery cells B, but there is only one pin P6 used for current sensing.

The over-voltage detection circuit 201 is coupled to the pins P1~P2 and the control circuit 205 respectively. The disconnection detection circuit 202 is coupled to the pin P6, the first over-current protection circuit 203 and the second over-current protection circuit 204 respectively. The first over-current protection circuit 203 is coupled to the disconnection detection circuit 202 and the control circuit 205 respectively. The second over-current protection circuit 204 is coupled to the disconnection detection circuit 202 and the control circuit 205 respectively for detecting the operating current IB of the battery cell B in a charging state. The control circuit 205 is coupled to the pins P3~P4, the over-voltage detection circuit 201, the first over-current protection circuit 203 and the second over-current protection circuit 204 respectively.

The disconnection detection circuit 202 is used to detect whether a disconnection occurs between the pin P6 and the path node PN and provide a first detection signal D1 accordingly. When there is no disconnection between the pin P6 and the path node PN, that is to say, when the pin P6 is still coupled to the path node PN, the first detection signal D1 provided by the disconnection detection circuit 202 will be related to the operating current IB. When a disconnection occurs between the pin P6 and the path node PN, the first detection signal D1 provided by the disconnection detection circuit 202 causes the first over-current protection circuit 203 to generate a first protection signal E1 to the control circuit 205 to turn off the discharge protection switch M1.

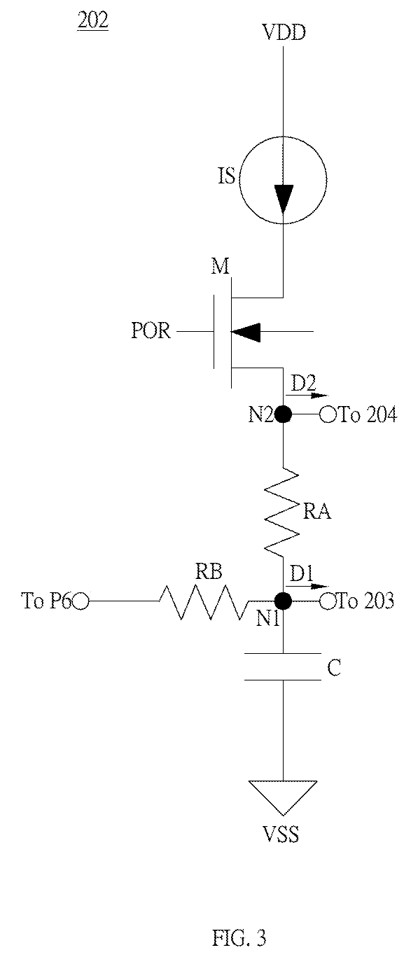

Please refer to FIG. 3, which is a schematic diagram of an embodiment of the disconnection detection circuit 202 in FIG. 2. As shown in FIG. 3, the disconnection detection circuit 202 includes a current source IS, a switch M, resistors RA and RB, a capacitor C and a first detection node N1. The current source IS, the switch M, the second detection node N2, the resistor RA, the first detection node N1 and the capacitor C are coupled in series between a first voltage VDD and a second voltage VSS. The switch M is controlled by a switch control signal POR to enable a disconnection detection function when the system power is ready. The resistor RB is coupled between the first detection node N1 and the pin P6. The resistor RB and the capacitor C are coupled to the first detection node N1 to form a filter circuit to block interference from external noise.

The first detection node N1 is also coupled to the first over-current protection circuit 203 for using the current source IS to provide the first detection signal D1 (that is, the node voltage of the first detection node N1) to the first over-current protection circuit 203. The second detection node N2 is coupled to the second over-current protection circuit 204 for generating the second detection signal D2 (that is, the node voltage of the second detection node N2) to the second over-current protection circuit 204.

In practical applications, a current value of the current provided by the current source IS can be 50~100nA; a resistance value of the resistor RA can be 10~100MΩ, but not limited to this. It should be noted that the high resistance value of the resistor RA combined with the low current provided by the current source IS can produce significant voltage changes at the first detection node N1 to reduce demand for current supplied by current source IS.

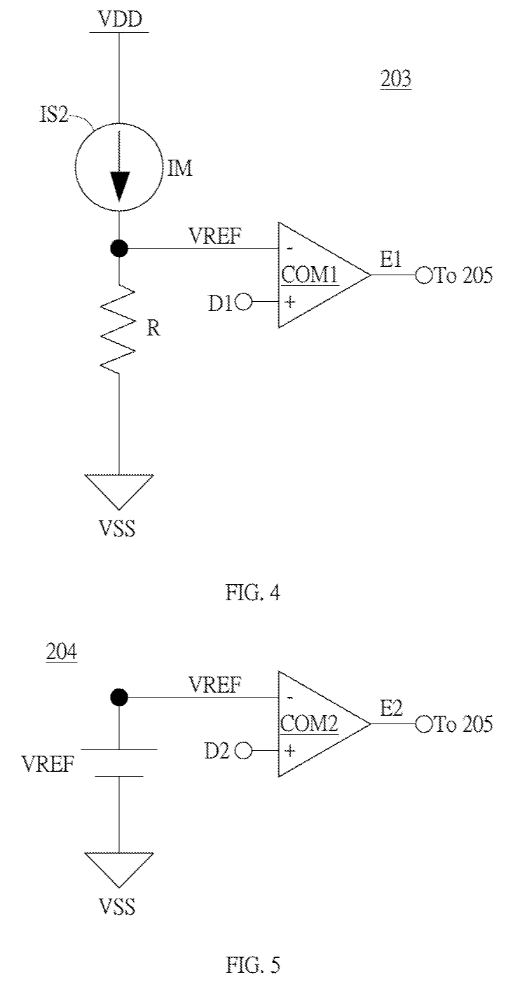

Please refer to FIG. 4, which is a schematic diagram of an embodiment of the first over-current protection circuit 203 in FIG. 2. As shown in FIG. 4, the first over-current protection circuit 203 is an over-discharge current detection circuit. The first over-current protection circuit 203 includes a current source IS2, a resistor R and a comparator COM1. The current source IS2 and the resistor R are coupled in series between the first voltage VDD and the second voltage VSS. The first voltage VDD is higher than the second voltage VSS. The current source IS provides a current IM to cooperate with the resistor R to generate a reference voltage VREF. A negative input terminal - of the comparator COM1 is coupled between the current source IS and the resistor R and receives the reference voltage VREF, and a positive input terminal + of the comparator COM1 receives the first detection signal D1 (that is, the node voltage of the first detection node N1).

When a comparison result generated by the comparator COM1 indicates that the node voltage of the first detection node N1 is greater than the reference voltage VREF, it means that an abnormal discharge current is detected. Therefore, the comparator COM1 will output the comparison result as a first protection signal E1 to the control circuit 205, so that the control circuit 205 generates a first control signal CTL1 to the pin P4 to turn off the discharge protection switch M1 and turn off the discharge path.

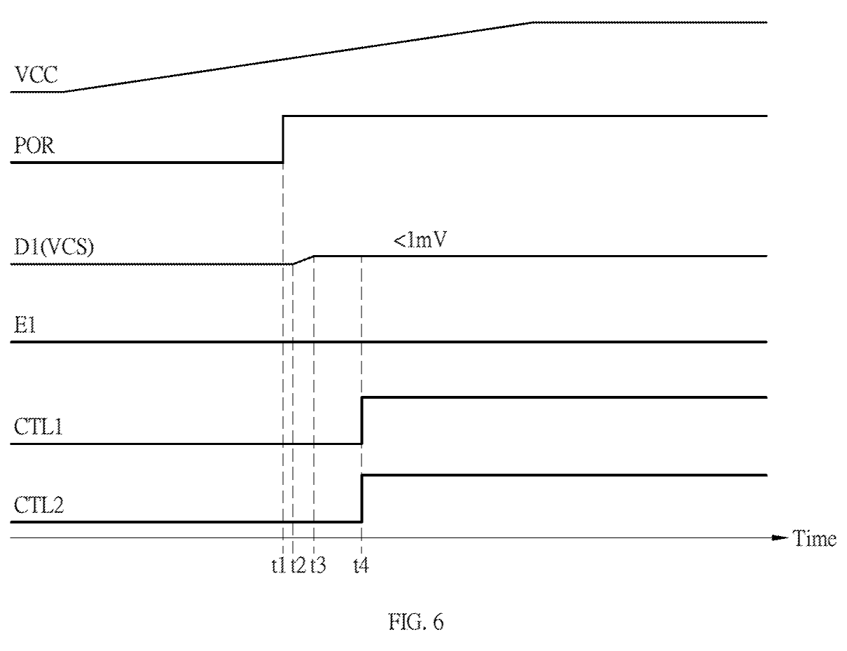

Please refer to FIG. 5, which is a schematic diagram of an embodiment of the second over-current protection circuit 204 in FIG. 2. As shown in FIG. 5, the second over-current protection circuit 204 is a charge over-current detection circuit. The second over-current protection circuit 204 compares the second detection signal D2 (that is, the node voltage of the second detection node N2) and the reference voltage VREF through the comparator COM2. When the comparison result is that the second detection signal D2 is greater than the reference voltage VREF, it means that an abnormal charging current has been detected. Therefore, the comparator COM2 will output the comparison result as a second protection signal E2 to the control circuit 205, so that the control circuit 205 generates a second control signal CTL2 to the pin P3 to turn off the charging protection switch M2 to turn off the charging path.

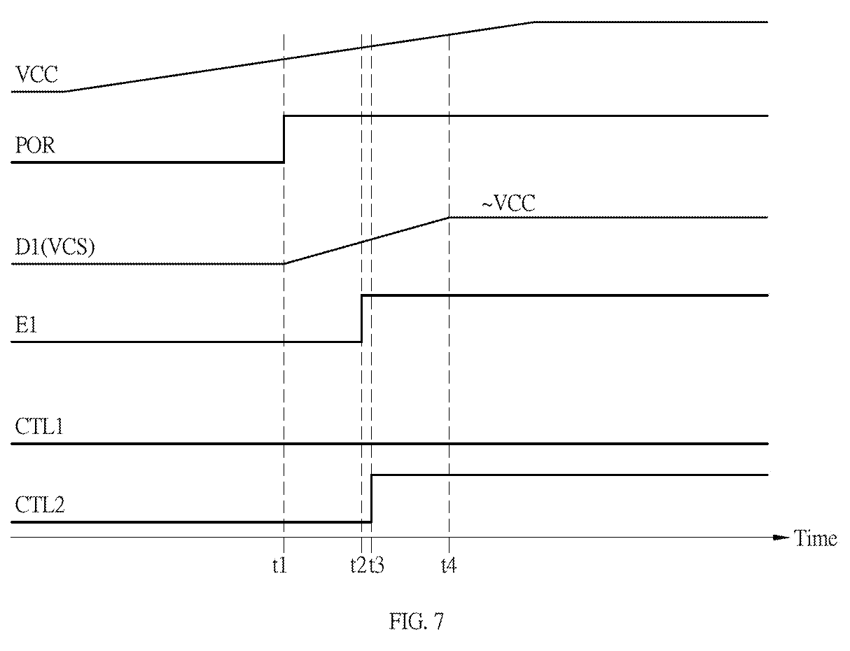

Please refer to FIG. 6, which is a waveform timing diagram of each signal when no disconnection occurs between the current sensing pin and the path node. As shown in FIG. 6, VCC is the operating voltage, POR is the switch control signal of the switch N in the disconnection detection circuit 202 (that is, the power ready signal of the system), and VCS is the node voltage of the first detection node N1 (that is, the first detection signal D1 which is a current sensing signal under the normal condition), E1 is the first protection signal generated by the first over-current protection circuit 203, CTL1 is the first control signal (that is, the discharge protection switch control signal), and CTL2 is the second control signal (that is, the charging protection switch control signal).

At the time t1, when the operating voltage VCC is charged to the IC enable voltage, the switch control signal POR changes from low-level to high-level to activate the disconnection detection function;

At the time t2, since the sensing current causes the first detection signal D1 (VCS) to rise slightly, but the rise amount is only less than 1mV, the first detection signal D1 (VCS) is still smaller than the reference voltage VREF, which does not affect Over-current protection function;

At the time t3, since the first detection signal D1 (VCS) is still less than the reference voltage VREF, which means that no disconnection occurs between the current sensing pin P6 and the path node PN, the first protection signal E1 generated by the first over-current protection circuit 203 is low-level; and

At the time t4, both the first control signal CTL1 and the second control signal CTL2 change from low-level to high-level to control the discharge protection switch M1 and the charging protection switch M2 to be turned on, that is to say, the charge/discharge paths are maintained turned on, so that the circuit can operate normally.

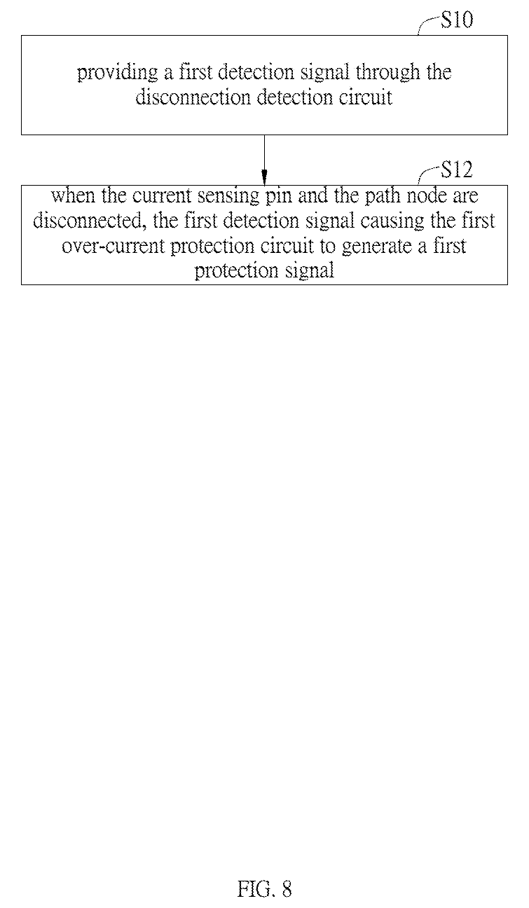

Please refer to FIG. 7, which is a waveform timing diagram of each signal when a disconnection occurs between the current sensing pin and the path node. As shown in FIG. 7, at the time t1, when the operating voltage VCC is charged to the IC enable voltage, the switch control signal POR changes from low-level to high-level to activate the disconnection detection function. The first detection signal D1 (VCS) continues to be pulled up due to the sensing current, and because the disconnection, the first detection signal D1 (VCS) continues to be pulled up until the time t4 when the first detection signal D1 (VCS) is approximately equal to the operating voltage VCC;

At the time t2, the first detection signal D1 (VCS) is greater than the reference voltage VREF, which represents a disconnection between the current sensing pin P6 and the path node PN, so the first protection signal E1 generated by the first over-current protection circuit 203 is high-level;

At the time t3, the second control signal CTL2 changes from low-level to high-level, while the first control signal CTL1 still maintains low-level to control the charging protection switch M2 to be turned on, but to control the discharge protection switch M1 not to be turned on, so the discharge path is turned off to provide discharge protection function.

Another specific embodiment of the invention is a method of operating a protection circuit of battery. In this embodiment, the protection circuit has a current sensing pin coupled to a path node. The path node, a battery cell and a protection switch are coupled in series. The protection circuit includes a disconnection detection circuit and a first over-current protection circuit. The disconnection detection circuit is coupled to the current sensing pin, and the first over-current protection circuit is coupled to the disconnection detection circuit.

Please refer to FIG. 8, which is a flowchart of the protection circuit of battery operating method in this embodiment. As shown in FIG. 8, the protection circuit of battery operating method includes the following steps of:

Step S10: providing a first detection signal through the disconnection detection circuit; and

Step S12: when the current sensing pin and the path node are disconnected, the first detection signal causing the first over-current protection circuit to generate a first protection signal.

In practical applications, when the current sensing pin is coupled to the path node, the first detection signal will be related to the operating current flowing through the battery cell, but not limited to this.

In one embodiment, the disconnection detection circuit includes a current source, a detection node and a resistor. The detection node is coupled to the current source, the current sensing pin and the first over-current protection circuit. The resistor is coupled between the first detection node and the current source. When the current sensing pin and the path node are disconnected, the disconnection detection circuit provides the first detection signal through the detection node, but not limited to this. In addition, the operating method can also generate the second detection signal through the second detection node between the resistor and the current source, but not limited to this.

In another embodiment, the protection circuit further includes a second current protection circuit. The operating method can also detect a current flowing through the battery cell in a charging state through the second current protection circuit, but not limited to this.

Compared to the prior art, the protection circuit of battery and its operating method of the invention can not only provide additional open-wire protection (OWP) function to the current sensing pin, but can also achieve the following effects at the same time:

(1) small increased power consumption: the power consumption of the disconnection detection circuit of the invention is about 50-100nA, which is only 1% of the power consumption (10-20uA) of the conventional disconnection detection circuit, so the increased power consumption is quite small; and

(2) small increased circuit area: the disconnection detection circuit of the invention is integrated with the over-current protection circuit, so the increased circuit area is quite small.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A protection circuit of battery having a current sensing pin coupled to a path node, the path node, a battery cell and a protection switch being coupled in series, the protection circuit comprising:
a disconnection detection circuit, coupled to the current sensing pin and configured to provide a first detection signal; and
a first over-current protection circuit, coupled to the disconnection detection circuit and configured to generate a first protection signal according to the first detection signal to turn off the protection switch;
wherein when the current sensing pin is disconnected from the path node, the first detection signal causes the first over-current protection circuit to generate the first protection signal.

2. The protection circuit of claim 1, wherein an operating current flows through the battery cell, when the current sensing pin is coupled to the path node, the first detection signal is related to the operating current.

3. The protection circuit of claim 1, wherein the disconnection detection circuit comprises a current source and a first detection node, the first detection node is coupled to the current source, the current sensing pin and the first over-current protection circuit, when the current sensing pin is disconnected from the path node, the first detection node uses the current source to provide the first detection signal.

4. The protection circuit of claim 3, wherein the disconnection detection circuit further comprises a resistor coupled between the first detection node and the current source, and the disconnection detection circuit generates a second detection signal at a second detection node located between the resistor and the current source.

5. The protection circuit of claim 1, further comprising:
a second current protection circuit configured to detect a current flowing through the battery cell when the battery cell is in a charging state.

6. A method of operating a protection circuit of battery, the protection circuit having a current sensing pin coupled to a path node, wherein the path node, a battery cell and a protection switch being coupled in series, the protection circuit comprising a disconnection detection circuit and a first over-current protection circuit, the disconnection detection circuit being coupled to the current sensing pin and the first over-current protection circuit being coupled to the disconnection detection circuit, the method comprising steps of:
providing a first detection signal through the disconnection detection circuit; and
when the current sensing pin is disconnected from the path node, the first detection signal causes the first over-current protection circuit to generate a first protection signal to turn off the protection switch.

7. The method of claim 6, further comprising:
when the current sensing pin is coupled to the path node, the first detection signal is related to an operating current flowing through the battery cell.

8. The method of claim 6, wherein the disconnection detection circuit comprises a current source and a first detection node, the first detection node is coupled to the current source, the current sensing pin and the first over-current protection circuit, the method further comprises a step of:
when the current sensing pin is disconnected from the path node, using the current source to provide the first detection signal through the first detection node.

9. The method of claim 8, wherein the disconnection detection circuit further comprises a resistor coupled between the first detection node and the current source, the method further comprises a step of:
generating a second detection signal through a second detection node between the resistor and the current source.

10. The method of claim 6, wherein the protection circuit further comprises a second current protection circuit, the method further comprises a step of:
detecting a current flowing through the battery cell when the battery cell is in a charging state through the second current protection circuit.
